(19) United States
(12) Patent Application Publication
(10) Pub. No.: US 2023/0026038 A1
(43) Pub. Date: Jan. 26, 2023

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yoshiki Iwakiri, Kanagawa (JP)

(21) Appl. No.: 17/858,239

(22) Filed: Jul. 6, 2022

(30) Foreign Application Priority Data
Jul. 16, 2021 (JP) 2021-117789

(51) Int. Cl. H04N 13/117; G06T 7/194; H04N 13/282; H04N 5/272; G06T 17/00

(52) U.S. Cl. CPC H04N 13/117; G06T 7/194; H04N 13/282; H04N 5/272; G06T 17/00; G06T 2207/10016

(57) ABSTRACT

A setting reception unit obtains information identifying an object selected by a user from foreground objects as a target to be a part of the background. A backgrounded target determination unit identifies the model ID of the selected object based on the object identifying information obtained and three-dimensional shape data. Based on the three-dimensional shape data, the determination unit identifies a foreground ID corresponding to the identified model ID, in a captured image from an actual camera. The determination unit obtains coordinate information and mask information in foreground data corresponding to the foreground ID identified, generates a correction foreground mask, and sends the mask to a background correction unit in an image processing unit. The background correction unit generates a correction image by masking the captured image using the mask, superimposes the correction image onto the background image, and outputs it as a corrected background image.

### BACKGROUND

### Field

The present disclosure relates to a technique for generating a virtual viewpoint image using a plurality of captured images.

### Description of the Related Art

Conventionally, there has been proposed a technique for generating a virtual viewpoint image by capturing images of a subject (an object) with a plurality of image capture apparatuses installed at different positions from a plurality of directions in synchronization and using the plurality of captured images thus captured and obtained. A virtual viewpoint image thus generated is an image that represents the view from a virtual viewpoint which is not limited to any of the positions where the image capture apparatuses are installed.

A virtual viewpoint image can be created by separating the foreground and the background in each of a plurality of captured images, generating foreground 3D models, and rendering each of the foreground 3D models thus generated. To generate a virtual viewpoint image this way needs separation of the foreground and the background, or in other words, extraction of the foreground, and one of the methods for this is background difference method.

In background difference method, an image without any moving objects (a background image) is generated in advance, a difference in luminance is found between a pixel in the background image and a corresponding pixel in a captured image from which to extract the foreground, and a region formed by pixels whose difference in luminance is equal to or greater than a threshold is extracted as a moving object (the foreground). To extract the foreground from a captured image using the background difference method, a background object in a background image and a background object in a captured image need to be associated with each other such that they coincide in position. For this reason, in a case where the position of a background object in a target captured image changes, the foreground cannot be extracted properly.

In this regard, Japanese Patent Laid-Open No. 2020-046960 discloses a technique in which upon detection of an object which is stationary for a certain period of time, the region where the object is displayed is written into the background image. Using this technique in Japanese Patent Laid-Open No. 2020-046960, even in a case where a background object moves and is now handled as a foreground object, the object is written into the background image after a lapse of a predetermined period of time and therefore is not extracted as the foreground.

However, Japanese Patent Laid-Open No. 2020-046960 needs to wait until a predetermined period of time passes in order to determine whether the object is stationary and therefore requires time to generate a proper background image.

### SUMMARY

An image processing apparatus according to the present disclosure includes: an obtainment unit that obtains a plurality of captured images captured and obtained by a plurality of image capture apparatuses; a background generation unit that generates a plurality of background images corresponding to the captured images from the respective image capture apparatuses, based on the plurality of captured images; a foreground extraction unit that extracts, as a foreground region on an object-by-object basis, a difference between each captured image of the plurality of captured images and a background image of the plurality of background images that corresponds to the captured image; and a determination unit that determines a foreground region corresponding to an object specified by a user, in each of the captured images from the respective image capture apparatuses, in which the background generation unit updates each of the plurality of background images based on the determined foreground region in a corresponding one of the captured images from the respective image capture apparatuses.

Further features of the present invention will become apparent from the following description of exemplary embodiments with reference to the attached drawings.

### BRIEF DESCRIPTION OF THE DRAWINGS

FIG. 1 is a diagram showing a system configuration according to an embodiment of the present disclosure;

FIG. 2 is a diagram showing an example arrangement of a plurality of actual cameras;

FIG. 3 is a diagram showing the hardware configuration of an image generation apparatus according to an embodiment of the present disclosure;

FIG. 4 is a diagram showing the functional configuration of the image generation apparatus according to an embodiment of the present disclosure;

FIG. 5A is a diagram showing an example of the process of generating a virtual viewpoint video according to an embodiment of the present disclosure;

FIG. 5B is a diagram showing an example of the process of generating a virtual viewpoint video according to an embodiment of the present disclosure;

FIG. 5C is a diagram showing an example of the process of generating a virtual viewpoint video according to an embodiment of the present disclosure;

FIG. 6 is a diagram showing an example of a foreground data list;

FIG. 7 is a diagram showing a table of correspondence between a model ID and foreground IDs included in captured images from respective actual cameras;

FIG. 8A is a diagram showing an example of a virtual viewpoint video in the event where a stationary object moves;

FIG. 8B is a diagram showing an example of a virtual viewpoint video in the event where a stationary object moves;

FIG. 8C is a diagram showing an example of a virtual t video in the event where a stationary object moves;

FIG. 9 is a diagram showing an example of a foreground data list;

FIG. 10 is a diagram showing a table of correspondence between a model ID and foreground 1Ds included in captured images from respective actual cameras;

FIG. 11 is a diagram showing a flowchart of processing for generating a correction foreground mask according to Embodiment 1 of the present disclosure;

FIG. 12A is a diagram showing an example of an UI fix selecting an object to be a part of the background according to an embodiment of the present disclosure;

FIG. 12B is a diagram showing an example of an UI for selecting an object to be a part of the background according to an embodiment of the present disclosure;

FIG. 13 is a diagram showing an example of a correction foreground mask according to an embodiment of the present disclosure;

FIG. 14 is a diagram showing a flowchart of processing performed a background correction unit according to an embodiment of the present disclosure;

FIG. 15 is diagrams illustrating processing performed by the background correction unit according to an embodiment of the present disclosure;

FIG. 16A is a diagram showing an example of a virtual viewpoint video according to an embodiment of the present disclosure in a case where a base background is used;

FIG. 16B is a diagram showing an example of a virtual viewpoint video according to an embodiment of the present disclosure in a case where a base background is used;

FIG. 16C is a diagram showing an example of a virtual viewpoint video according to an embodiment of the present disclosure in a case where a base background is used; and

FIG. 17 is a diagram showing a flowchart of processing for generating a correction foreground mask according to Embodiment 2 of the present disclosure.

### DESCRIPTION OF THE EMBODIMENTS

An information processing system of the present embodiment is described. The information processing system of the present embodiment has the capability of switching between a video captured by an image capture apparatus such as, for example, a broadcast camera that actually performs image capture (hereinafter referred to as an actual camera) and a virtual viewpoint video corresponding to a virtual viewpoint and outputting the video. A video captured by an actual camera is hereinafter also referred to as an actual camera video. A virtual viewpoint is a viewpoint designated by a user. For the illustration convenience, a camera virtually placed at the position of a virtual viewpoint (hereinafter referred to as a virtual camera) is used in the following description. Thus, the position of a virtual viewpoint and the line-of-sight direction from the virtual viewpoint correspond to the position and the attitude of the virtual camera, respectively. Also, the field of view (the visual field) from the virtual viewpoint corresponds to the angle of view of the virtual camera.

Also, a virtual viewpoint video in the present embodiments is called a free viewpoint video as well, but a virtual viewpoint video is not limited to a video corresponding to a viewpoint freely (arbitrarily) designated by a user and includes, for example, an image corresponding to a viewpoint selected by a user from a plurality of candidates. Also, the present embodiments mainly describe a case where a virtual viewpoint is designated by a user operation, but a virtual viewpoint may be automatically designated based on, e.g., results of image analysis. Also, the present embodiments mainly describe a case where a virtual viewpoint video is a moving image. A virtual viewpoint video can be regarded as a video captured by a virtual camera.

Embodiments of the present disclosure are described below with reference to the drawings.

### [Embodiment 1]

In the present embodiment, each of a plurality of captured images captured and obtained by a plurality of image capture apparatuses is separated into a foreground region and a background region, a virtual viewpoint image representing at least a foreground object corresponding to the foreground region is generated, and then a user selects, on the virtual viewpoint image, a foreground object desired to be a part of the background. Then, the foreground region corresponding to the selected foreground object is identified in each of the captured images from the respective image capture apparatuses, arid the background image prepared for each of the captured images from the respective image capture apparatuses is updated based on the foreground region thus identified. Performing foreground and background separation in each captured image based on the updated background image causes the virtual viewpoint image to be updated as well.

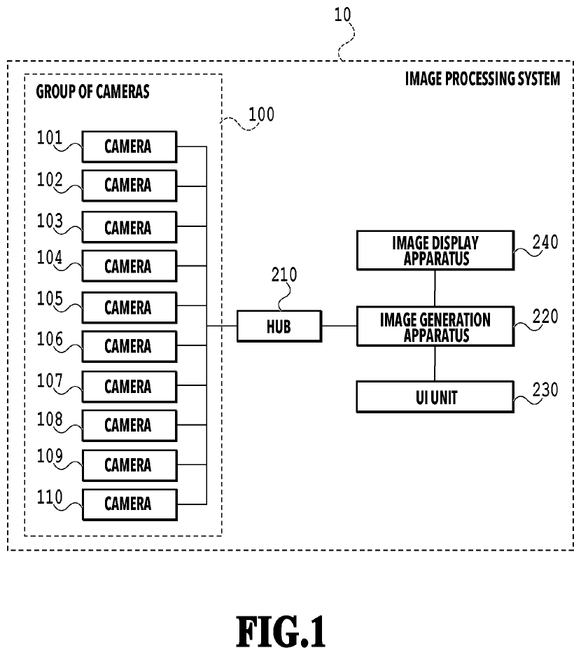

FIG. 1 shows an example configuration of an image processing system 10 of the present embodiment that generates a virtual viewpoint image. The image processing system 10 includes a group of actual cameras 100 having actual cameras 101 to 110, a hub 210 connected to each of the actual cameras 101 to 110, and an image generation apparatus 220 that is connected to the group of actual cameras 100 via the hub 210 and generates a virtual viewpoint image. The image processing system 10 also has a user interface (UI) unit 230 used to operate the image generation apparatus 220 and an image display apparatus 240 that displays the virtual viewpoint image generated by the image generation apparatus 220.

Note that the configuration of the image processing system 10 is not limited to the one shown in FIG. 1. The plurality of actual cameras 101 to 110 included in the group of actual cameras 100 may be connected directly to the image generation apparatus 220 or may be connected to one another as a daisy chain with only one of the actual cameras being connected to the image generation apparatus 220. The image generation apparatus 220 may be formed by a plurality of apparatuses, or the image generation apparatus 220 may have the UI unit 230 therein. The apparatuses included in the image processing system 10 may be connected in a wired manner or in a wireless manner.

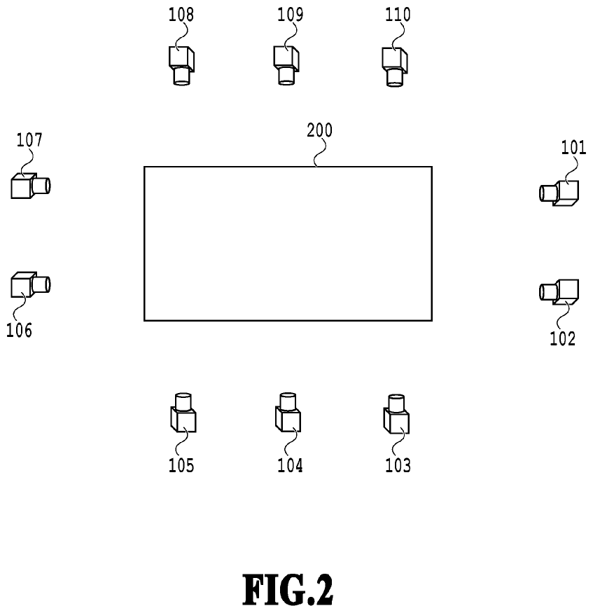

FIG. 2 shows an example arrangement of the actual cameras 101 to 110 of the group of actual cameras 100. The actual cameras 101 to 110 are arranged to surround an image capture region 200 to be captured and obtain captured images by capturing images of the image capture region 200 from positions different from one another in order to generate a virtual viewpoint image. Each of the actual cameras 101 to 110 included in the group of actual cameras 100 is for example a digital camera, and may be an image capture apparatus that captures still images, an image capture apparatus that captures moving images, or an image capture apparatus that captures both still images and moving images, In the present embodiment, the term “image” includes a still image and a moving image unless otherwise noted. Note that in the present embodiment, an image capture part that has an image capture sensor and a lens that concentrates light beams into the image capture sensor are collectively called an image capture apparatus or an actual camera. The image processing system 10 generates a virtual viewpoint image of the inside of the image capture region 200 by using a plurality of captured images captured and obtained by the group of actual cameras 100. Note that the number of actual cameras included in the group of actual cameras 100 is not limited to ten as exemplified in the present embodiment, as long as more than one actual camera is included. Also, the group of actual cameras 100 do not have to surround the image capture region 200 from all directions.

Captured images captured and obtained by the group of actual cameras 100 are sent to the image generation apparatus 220 via the hub 210. The image generation apparatus 220 receives an instruction for virtual viewpoint image generation processing via the UI unit 230 and generates a virtual viewpoint image in accordance with the position and the line-of-sight direction of the virtual viewpoint which is set in the instruction received. The UI unit 230 has an operation unit such as a mouse, a keyboard, an operation button, or a touch panel and receives user operations.

The image generation apparatus 220 generates at least foreground 3D models (three-dimensional shape data) based on a plurality of captured images captured and obtained by the actual cameras 101 to 110 and performs rendering processing on the three-dimensional shape data in accordance with the position and the line-of-sight direction of the virtual viewpoint set. The image generation apparatus 220 thus generates a virtual viewpoint image that represents the view from the virtual viewpoint. For the processing for generating a virtual viewpoint image from a plurality of captured images, a known method such as the Visual Hull can be used. Note that an algorithm for generating a virtual viewpoint image is not limited to this.

The image display apparatus 240 obtains and displays a virtual viewpoint image generated by the image generation apparatus 220.

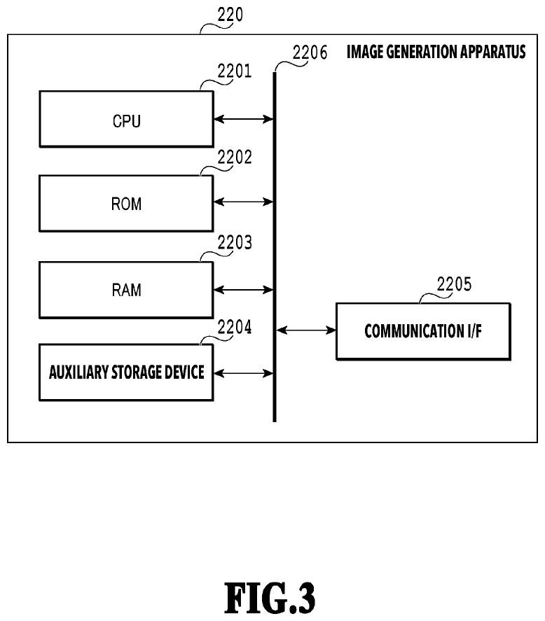

FIG. 3 shows an example hardware configuration of the image generation apparatus 220. The image generation apparatus 220 has a CPU 2201, a ROM 2202, a RAM 2203, an auxiliary storage device 2204, a communication I/F 2205, and a bus 2206. The CPU 2201 performs overall control of the image generation apparatus 220 using computer programs and data stored in the ROM 2202 and the RAM 2203. Note that the image generation apparatus 220 may have one or more dedicated processing circuits besides the CPU 2201 so that the dedicated processing circuit may perform at least part of the processing otherwise performed by the CPU 2201, Examples of the dedicated processing circuit include an application-specific integrated circuit (ASIC), a field-programmable gate array (FPGA), and a digital signal processor (DSP). The ROM 2202 stores programs and parameters that do not need change. The RAM 2203 temporarily stores, e.g., programs and data supplied from the auxiliary storage device 2204 and data supplied externally via the communication I/F 2205. The auxiliary storage device 2204 is configured by, for example, an SSD, an HDD, or the like, and stores therein various kinds of contort data such as images and audio.

The communication I/F 2205 is used for communications with external devices such as the group of actual cameras 100. For example, in a case where the image generation apparatus 220 is connected to an external device in a wired manner, a communication cable is connected to the communication I/F 2205. In a case where the image generation apparatus 220 has a capability of wireless communications with an external device, the communication I/F 2205 includes an antenna. The bus 2206 connects the units in the image generation apparatus 220 to one another and communicates information therebetween. Note that in a case where the image generation apparatus 220 has the UI unit 230 therein, the image generation apparatus 220 has a display unit and an operation unit in addition to the configuration shown in FIG. 3.

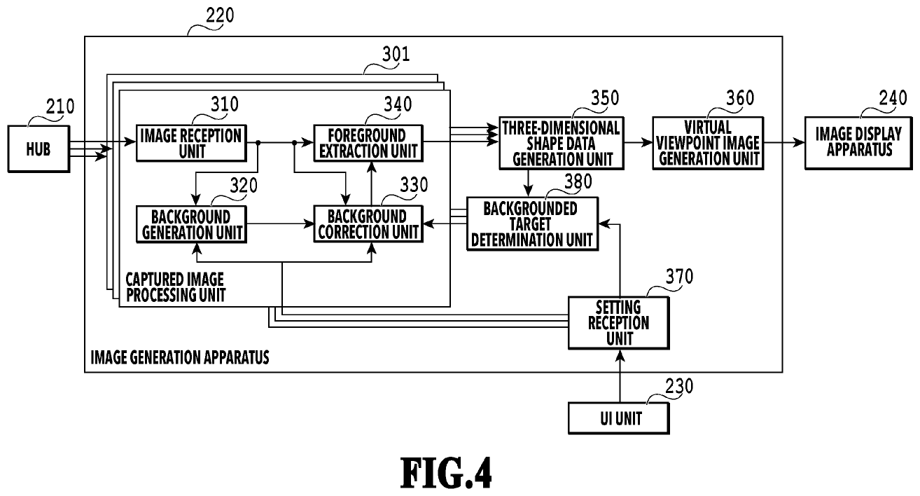

FIG. 4 shows a functional configuration of the image generation apparatus 220 according to an embodiment of the present disclosure. The image generation apparatus 220 has a captured image processing unit 301, a three-dimensional shape data generation unit 350, a virtual viewpoint image generation unit 360, a setting reception unit 370, and a backgrounded target determination unit 380.

The captured image processing unit 301 receives a captured image outputted from the actual camera 101, separates the captured image into a foreground region and a background region using background difference method to extract the foreground region, and outputs the foreground region. The captured image processing unit 301 includes a plurality of processing units corresponding to the respective actual cameras 101 to 110, and each processing unit receives a captured image from its corresponding actual camera, extracts a foreground region, and outputs the foreground region. Each processing unit in the captured image processing unit 301 has an image reception unit 310, a background generation unit 320, a background correction unit 330, and a foreground extraction unit 340.

The image reception unit 310 receives a captured image outputted from one of the actual cameras 101 to 110 via the hub 210 and outputs the captured image to the background generation unit 320, the background correction unit 330, and the foreground extraction unit 340.

The background generation unit 320 receives a captured image from the image reception unit 310 and stores a captured image designated by a user instruction or the like as a background image. The timing for the storage does not have to be the timing of receiving a user instruction, and there is no particular limitation. The background generation unit 320 outputs the background image thus stored to the background correction unit 330.

The background correction unit 330 obtains a correction foreground mask from the backgrounded target determination unit 380 to he described later and generates a correction image by applying the correction foreground mask to the captured image obtained from the image reception unit 310. The background correction unit 330 then generates a corrected background image by superimposing the correction image onto the background image obtained from the background generation unit 320 and outputs the corrected background image to the foreground extraction unit 340. In a case where there is no correction image, the background correction unit 330 outputs the background image to the foreground extraction unit 340 as it is. Details of this processing will be described later,

The foreground extraction unit 340 finds differences between the captured image obtained from the image reception unit 310 and the background image or the corrected background image obtained from the background correction unit 330 and extracts, as a foreground region, a region in the captured image formed by pixels whose difference value is determined to be equal to or greater than a predetermined threshold. The foreground extraction unit 340 then generates foreground data on an object-by-object basis, the foreground data including foreground ID information, coordinate information, mask information defining the contour of the foreground region, and texture information on the foreground region, and outputs the foreground data to the three-dimensional shape data generation unit 350. Details of the foreground data will be described later. Pieces of foreground data corresponding to the actual cameras 101 to 110 and outputted from the respective processing units in the captured image processing unit 301 are gathered by the three-dimensional shape data generation unit 350.

The three-dimensional shape data generation unit 350 generates three-dimensional shape data based on pieces of foreground data corresponding to the respective actual cameras 101 to 110 obtained from the respective processing units in the captured image processing unit 301. Generally used methods such as the Visual Hull is used to generate the three-dimensional shape data. The Visual Hull is a method for obtaining three-dimensional shape data by finding the intersection of visual cones formed in a three-dimensional space based on mask information in a plurality of pieces of foreground data generated from a plurality of captured images captured and obtained by different actual cameras at the same time. The three-dimensional shape data generation unit 350 outputs the generated three-dimensional shape data to the virtual viewpoint image generation unit 360. Note that in the process of generating the three-dimensional data, pieces of foreground data on the same object are associated with each other between the captured images from the different actual cameras.

Based on a set virtual viewpoint, the virtual viewpoint image generation unit 360 generates a virtual viewpoint image of the foreground by performing rendering processing using three-dimensional shape data of the foreground obtained from the three-dimensional shape data generation unit 350 and texture information included in the corresponding foreground data. In this event, a virtual viewpoint image of the background may be similarly generated and combined with the virtual viewpoint image of the foreground. Note that a virtual viewpoint image including the foreground and the background may be generated by rendering the foreground and the background separately and combining them, or may be generated by rendering the foreground and the background simultaneously.

The setting reception unit 370 obtains user instruction information from the UI unit 230. The user instruction information includes background storage instruction information, background correction control instruction information, and object-to-be-backgrounded selection instruction information.

The background storage instruction information is information instructing storage of a background image, and is outputted to the background generation unit 320. Upon receipt of the background storage instruction information, the background generation unit 320 stores a captured image obtained from the image reception unit 310 as a background image and outputs the background image to the background correction unit 330.

The background correction control instruction information is information used to control ON and OFF of the capability of correcting the background image stored, and is outputted to the background correction unit 330, Upon receipt of the background correction control instruction information, the background correction unit 330 enables or disables the processing for correcting the background image stored in the background generation unit 320. In a case of receiving correction off information, the correction processing is disabled. More specifically, the background correction unit 330 receives the background image outputted from the background generation unit 320 and outputs it to the foreground extraction unit 340 as it is.

The object-to-be-backgrounded selection instruction information is information used to identify a foreground object desired to be a part of the background in the virtual viewpoint image generated by the virtual viewpoint image generation unit 360, and is outputted to the three-dimensional shape data generation unit 350.

The backgrounded target determination unit 380 obtains information on the object to be a part of the background from the setting reception unit 370. The information on the object to be a part of the background is information related to an object desired to be a part of the background among the foreground objects displayed on the virtual viewpoint image. From pieces of three-dimensional shape data obtained from the three-dimensional shape data generation unit 350, the backgrounded target determination unit 380 detects three-dimensional shape data corresponding to the foreground object indicated by the obtained information on the object to be a part of the background. Then, the backgrounded target determination unit 380 identifies pieces of foreground data corresponding to the respective actual cameras that are associated with the detected three-dimensional shape data. Details of this processing for identifying foreground data corresponding to the object to be a part of the background will be described later. The backgrounded target determination unit 380 generates a mask for the object to be a part of the background for each actual camera based on the obtained foreground data corresponding to the actual camera, and outputs the mask for the object to be a part of the background to the background correction unit 330 of the corresponding processing unit in the captured image processing unit 301. Details of the processing will be described later.

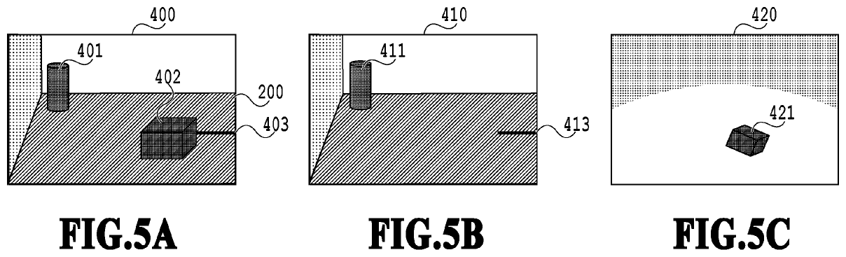

FIGS. 5A to 5C show examples of how a captured image, a background image, and a virtual viewpoint image are displayed in a case of normality. By a case of normality, it means that a virtual viewpoint image generated has a desired object extracted as the foreground. FIG. 5A shows a captured image 400 obtained by the actual camera 101 by capturing part of the image capture region 200. The captured image 400 has a cylinder 401, a box 402, and a cable 403. FIG. 5B shows a background image 410 which is a captured image having a cylinder 411 and a cable 413 and having no box 402, compared to the captured image obtained by the actual camera 101 by capturing the image capture region 200. Note that the background image 410 may be one generated by combining images of regions having no box 402 from a plurality of captured images. As a result of processing the images in FIGS. 5A and 5B using background difference method, the box 402 is extracted as the foreground. FIG. 5C shows a virtual viewpoint video 420 generated based on the foreground data extracted from the captured images obtained by all the actual cameras by capturing the image capture region 200 at the same time. An object 421 is an object corresponding to the box 402 shown in FIG. 5A.

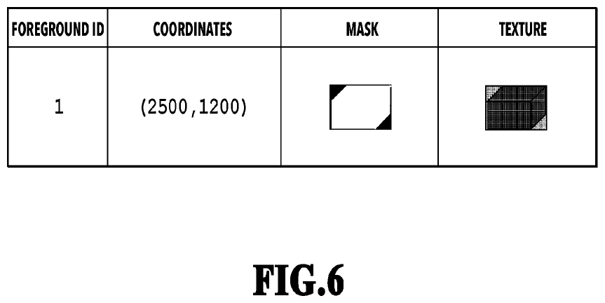

FIG. 6 shows an example of foreground data extracted by the foreground extraction unit 340, the foreground data shown being generated based on a foreground region extracted by performing background difference method on the captured image 400 and the background image 410 shown in FIGS. 5A and 5B. The foreground data is formed by foreground ID information for identifying a foreground region on an object-by-object basis in each captured image, coordinate information representing where in the captured image the foreground region is located, mask information defining the contour of the foreground region, and texture information representing the color tone and texture of the surface of the object.

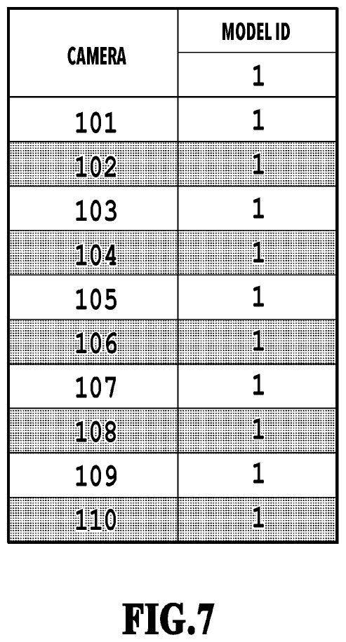

FIG. 7 is a table of correspondence between a model ID identifying three-dimensional shape data on an object-by-object basis generated by the three-dimensional shape data generation unit 350 and foreground IDs in captured images from the respective actual cameras used to generate the three-dimensional shape data on an object-by-object basis. The correspondence table associates model ID information and foreground ID information with each other, the model ID information being for identifying a three-dimensional shape on an object-by-object basis forming a continuous space, the foreground ID information being in each of pieces of foreground data generated from captured images from the respective actual cameras used to generate the three-dimensional shape data identified by the model ID information. Model ID 1 represents the object 421 in FIG. 5C and indicates that three-dimensional shape data has been generated by extracting, as the foreground, an object corresponding to the box 402 in FIG. 5A in each of the captured images from the respective actual cameras.

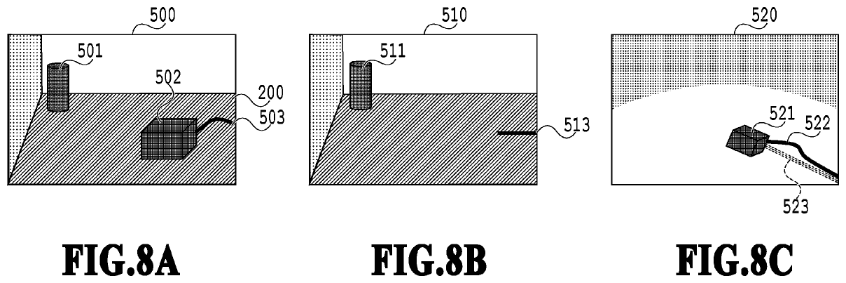

FIGS. 8A to 8C show examples of how a captured image, a background image, and a virtual viewpoint image are displayed in a case of abnormality. By a case of abnormality, it means that in a virtual viewpoint image generated, an object undesired as the foreground is rendered as the foreground. This example shows a case where as a result of moving the cable 403 shown in FIG. 5A, an object corresponding to the moved cable is shown on the virtual viewpoint image as the foreground. FIG. 8A shows a captured image 500 obtained by the actual camera 101 by capturing part of the image capture region 200. The captured image 500 has a cylinder 501, a box 502, and a cable 503 like in FIG. 5A, but the cable 503 has been moved from the position of the cable 403 in the captured image 400 in the case of normality shown in FIG. 5A. FIG. 8B shows a background image 510 which is a captured image having a cylinder 511 and a cable 513 and having nothing corresponding to the box 502, compared to the captured image obtained by the actual camera 101 by capturing part of the image capture region 200. FIG. 8B is the same as FIG. 5B. Note that the background image 510 may be one generated by combining images of regions having no box 502 in a plurality of captured images, as is similar to FIG. 5B. As a result of processing these images in FIGS. 8A and 8B using background difference method, not only the box 502 and the cable 503, but also a region on the captured image 500 corresponding to the region on the background image 510 where the cable exists is extracted as the foreground. FIG. 8C shows a virtual viewpoint image 520 generated based on the foreground data generated from the captured images obtained by all the actual cameras by capturing the image capture region 200 at the same time. An object 521 is an object corresponding to the box 502 in the captured image 500. An object 522 is an object corresponding to the cable 503 in the captured image 500, and an object 523 is an object corresponding to a region on the captured image 500 where the cable 513 in the background image 510 is located.

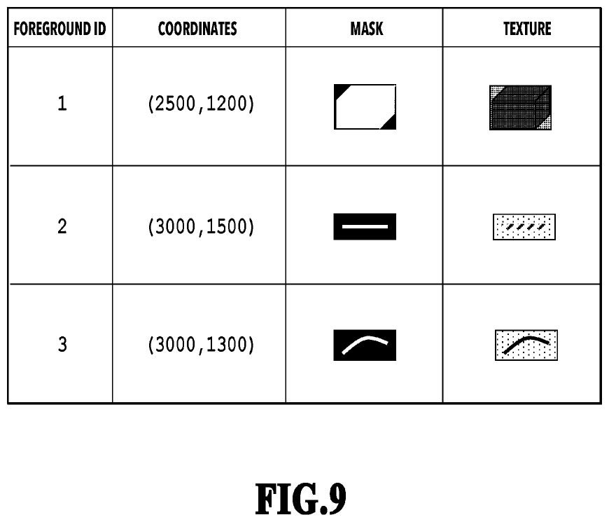

FIG. 9 shows an example of foreground data generated by the foreground extraction unit 340, the foreground data shown being generated based on foreground regions extracted by performing background difference method on the captured image 500 shown in FIG. 8A and the background image 510 shown in FIG. 8B obtained from the actual camera 101. Because the position of the cable 503 in the captured image 500 has moved relative to the cable 513 in the background image 510, two unwanted foreground regions of foreground ID 2 and foreground ID 3 are extracted besides the foreground region of foreground ID 1.

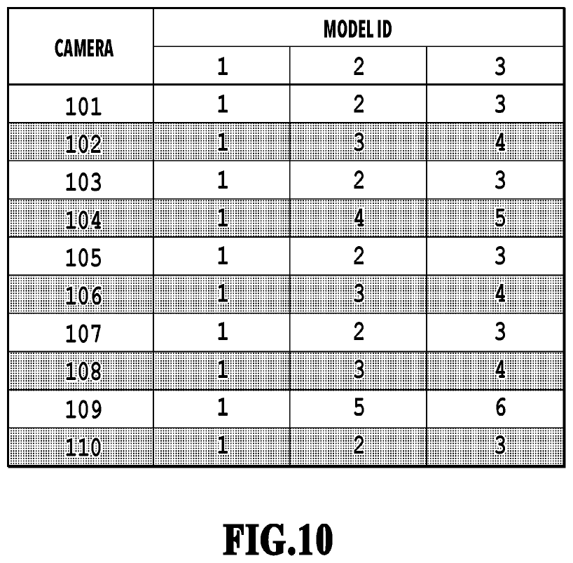

FIG. 10 is a table of correspondence between a model ID identifying three-dimensional shape data on an object-by-object basis generated by the three-dimensional shape data generation unit 350 and foreground IDs in captured images from the respective actual cameras used to generate the three-dimensional shape data on an object-by-object basis. Note that this information indicating the correspondence between a model ID and foreground IDs in captured images from the respective actual cameras is included in three-dimensional shape data. Model ID 1, model ID 2, and model ID 3 correspond to the objects 521, 522, and 523, respectively, in the virtual viewpoint image 520 in FIG. 8C. Checking the model ID of three-dimensional shape data enables identification of foreground IDs in captured images from the respective actual cameras used to generate the three-dimensional shape data. In order for the virtual viewpoint image 520 to have only the object 521 corresponding to the box 502 displayed as the foreground like the virtual viewpoint image 420 in the case of normality, the model ID 2 and the model ID 3 need to be changed to the background.

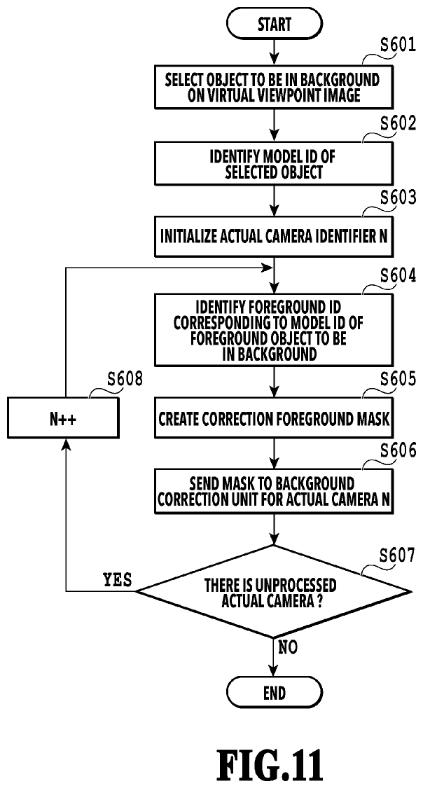

FIG. 11 shows a flowchart, of processing for generating a correction foreground mask for correcting a background image.

First, in S601, from the UI unit 230, the setting reception unit 370 obtains information identifying an object to be a part of the background selected by a user from foreground objects on a virtual viewpoint image displayed on the image display apparatus 240.

In S602 the backgrounded target determination unit 380 identifies the model ID of the selected object based on the information obtained in S601 and three-dimensional shape data.

In S603, the backgrounded target determination unit 380 initializes an identifier N for identifying an actual camera. In the present embodiment, the initial value of N is set to 101, and processing is performed starting from the captured image captured and obtained by the actual camera 101.

In S604, based on the three-dimensional shape data, the backgrounded target determination unit 380 identifies a foreground ID corresponding to the model ID identified in S602 in the captured image from the actual camera N. Note that depending on the position and attitude of the actual camera, the captured image from the actual camera N may have no foreground ID corresponding to the identified model ID. In such a case, from other captured images captured at different timings or different frames in a case where the captured image is a moving image, a captured image or a frame having a foreground ID corresponding to the identified model ID may be used for the processing.

In S605, the backgrounded target determination unit 380 obtains coordinate information and mask information included in the foreground data corresponding to the foreground ID identified in S604 and generates a correction foreground mask.

In S606, the backgrounded target determination unit 380 sends the correction mask generated in S605 to the background correction unit 330 of the processing unit in the captured image processing unit 301 corresponding to the actual camera N.

In S607, the backgrounded target determination unit 380 determines whether there is any unprocessed captured image. The backgrounded target determination unit 380 proceeds back to S604 via S608 if there is any unprocessed captured image (Yes in S607), and ends this processing if all the captured images have been processed (No in S607).

In S608, the backgrounded target determination unit 380 increments the actual camera identifier N and proceeds back to S604.

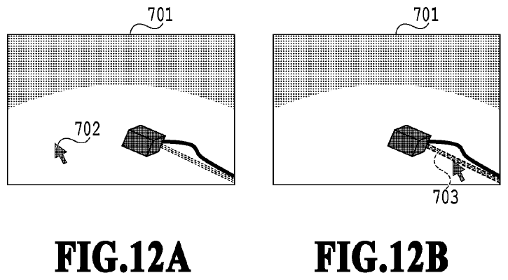

FIGS. 12A and 12B show an example of a screen displayed on the image display apparatus 240 in S601 for a user to select, on a virtual viewpoint image, a foreground object to be a part of the background. An image 701 is a video outputted by the image display apparatus 240. A pointer 702 is a pointer for selecting a foreground object to be a part of the background, and is controlled by the UI unit 230. FIG. 12A shows a state where no foreground object is being selected, and FIG. 12B shows a state where a foreground object is being selected. With the pointer 702 moved onto the foreground object to be a part of the background, a determination operation is executed by the UI unit 230. Then, like an object 703, the foreground object is displayed differently in such a manner that the contour of the foreground object is highlighted, indicating that the foreground object is being selected. Note that the shape of the pointer 702 is not limited to a particular shape, as lone as a foreground object can be selected with it. The indication that a foreground object is being selected is not necessarily have to be highlighting the contour of the foreground object and is not limited to a particular indication, as lone as the indication makes it clear that the foreground object is being selected. Also, instead of specifying a foreground object on a virtual viewpoint image, a list of foreground objects may be displayed to have a foreground object selected from the list. Further, instead of displaying a virtual viewpoint image or a list on the image display apparatus 240, any other configurations may be employed as long as a foreground object can be selected. Lastly, with an operation of ending the foreground object selection processing, the foreground object being selected is determined as an object to be a part of the background.

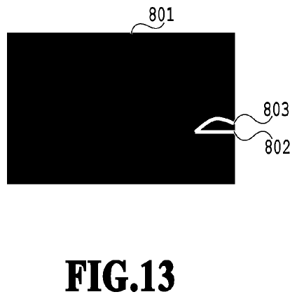

FIG. 13 shows an example of a correction foreground mask generated in S606. FIG. 13 depicts a correction foreground mask applied to a captured image captured and obtained by the actual camera 101 in a case where model ID 2 and model ID 3 in FIG. 10 are selected as objects to be a part of the background. In S604, based on three-dimensional shape data, coordinate information and mask information included in foreground data of the foreground ID 2 and the foreground ID 3 corresponding to the model ID 2 and the model ID 3, respectively, are obtained. Then, a mask 802 based on the mask information for foreground ID 2 and a mask 803 based on the mask information for foreground ID 3 are placed at the positions indicated by their respective pieces of coordinate information, thereby generating a single correction foreground mask 801.

Note that there may be a capability for taking an object which has been determined as an object to be a part of the background and is no longer displayed as the foreground and displaying the object again as the foreground. For example, in a case where a list of model IDs of objects moved to the background is held, objects of the model IDs in the list are displayed again on the virtual viewpoint video in such a manner that they are being selected, and objects unselected are removed from the list of objects changed to the background. A correction foreground mask associated with a model ID removed from the list of objects changed to the background and a correction image for correcting a background image generated using the correction foreground mask are also removed. Because the background image no longer has objects corresponding to the model IDs removed from the list, an object determined to be displayed again is extracted as the foreground and is displayed as the foreground again on the virtual viewpoint video.

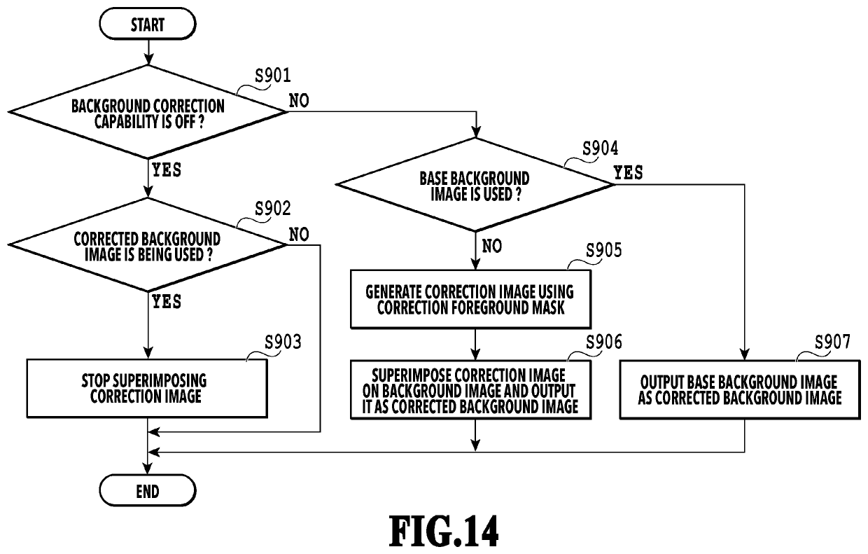

FIG. 14 shows a flowchart of processing performed by the background correction unit 330. First, the background correction unit 330 checks the status of the background correction capability. The status is changed based on the aforementioned background correction control instruction information outputted from the UI unit 230.

In S901, the background correction unit 330 determines whether the background correction capability is off. The background correction unit 330 proceeds to S902 if the background correction capability is off (Yes in S901), and proceeds to 5904 if the background correction capability is on (No in S901),

In S902, the background correction unit 330 determines whether a corrected background image, which already has a correction image superimposed on a background image, is being used. The background correction unit 330 proceeds to 5903 if a corrected background image is being used (Yes in S902), and ends the processing if a corrected background image is not being used (No in S902).

In S903, the background correction unit 330 stops using the correction image included in the corrected background image.

In this way, if the background correction capability is off (Yes in S901), a pre-update, uncorrected background image is outputted to the foreground extraction unit 340.

In S904, the background correction unit 330 checks whether to use a base background image as a corrected background image. A base background image is an image haying no possible foreground objects in the image capture region 200. Whether to use a base background image is determined based on a user input performed by a user via the UI unit 230. The background correction unit 330 proceeds to S905 if a base background image is not used (No in S904), and proceeds to S907 if a base background image is used (Yes in S904).

In S905, the background correction unit 330 masks the captured image using the correction foreground mask generated by the backgrounded target determination unit 380 and thereby generates a correction image.

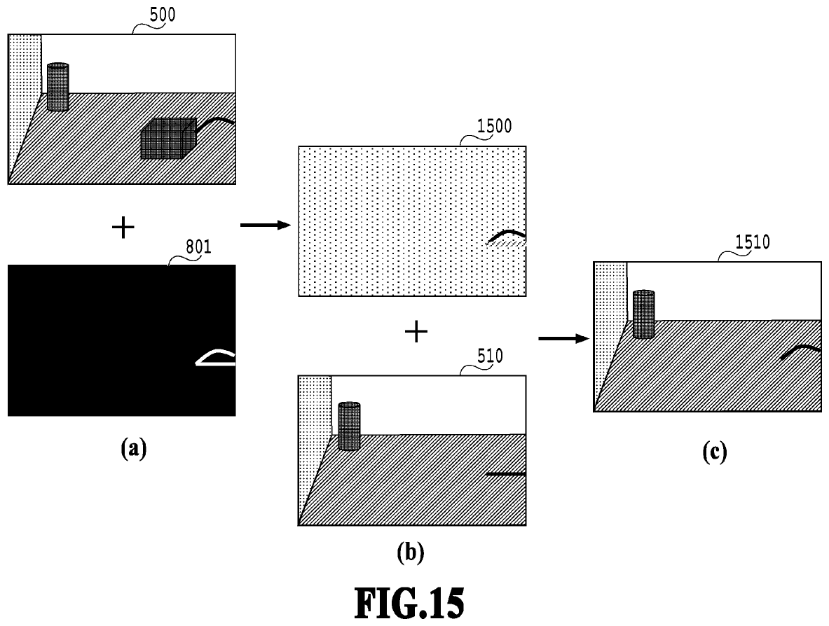

In S906, the background correction unit 330 superimposes the correction image thus generated onto the background image obtained from the background generation unit 320 and outputs the result as a corrected background image to the foreground extraction unit 340. FIG. 15 is diagrams illustrating the process of generating a corrected background image. FIG. 15 (a) shows the captured image 500 in FIG. 8A from the actual camera 101 and the correction foreground mask 801 in FIG. 13 generated by the backgrounded target determination unit 380. FIG. 15 (b) shows a correction image 1500 generated from the captured image 500 and the correction foreground mask 801 and the background image 510 in FIG. 8B. The correction image 1500 is generated by masking the captured image 500 with the correction foreground mask 801. FIG. 15 (c) shows a corrected background image 1510 generated by superimposition of the correction image 1500 onto the background image in FIG. 8B. This corrected background image 1510 is a corrected background image in which the cable is moved relative to the pre-correction background image 510. The foreground extraction unit 340 performs foreground extraction using background difference method based on this corrected background image 1510, and then, the cable is no longer extracted as the foreground. Thus, a virtual viewpoint image having the cable in the background can be outputted.

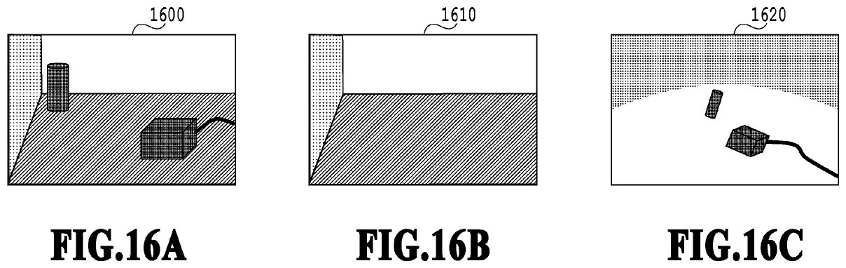

In S907, the background correction unit 330 outputs a base background image as a corrected background image to the foreground extraction unit 340. FIGS. 16A to 16C are diagrams illustrating the scenario where a base background image is used as a corrected background image. FIG. 16A shows a captured image 1600 captured and obtained by the actual camera 101, and FIG. 16B shows a base background image 1610 for the captured image captured and obtained by the actual camera 101. The base background image 1610 is a captured image captured and obtained by the actual camera 101 without any foreground object in the image capture region 200 or an image obtained by collecting regions with no foreground object from a plurality of captured images and combining them. FIG. 16C shows a virtual viewpoint image generated based on foreground regions obtained by foreground extraction using base background images for the captured images from the respective actual cameras.

A base background image is effective in a case of, e.g., displaying all the objects placed inside the image capture region 200 at once on a virtual viewpoint image temporarily. While an object which is in the background image from the start cannot be extracted as the foreground after that, an object extracted as the foreground once can be changed into a background object. Thus, a base background image is also effective in increasing the degree of freedom of the background image. To generate a desired background image from a base background image, a user may be prompted to select an object desired to be a part of the background from the objects displayed as the foreground on a virtual viewpoint image, and a correction image corresponding to the selected object may be superimposed onto the base background image 1610.

The background correction unit 330 can update a background image by outputting a generated corrected background image to the foreground extraction unit 340.

Note that it takes time to generate a virtual viewpoint image because high-load processing such as foreground extraction and generation of three-dimensional shape data is necessary. Also, a virtual viewpoint image after background image correction is generated based on captured images captured at a time prior to the time at which the virtual viewpoint image is displayed. Thus, in a case where a user selects an object to be a part of the background with the object moving in the image capture region, using captured images captured at the time of the selection may result in that the object is no longer at that position. Thus, the background correction unit 330 may have a capability of retaining a certain period of time's worth of captured images for a certain time period obtained from the image reception unit 310. For example, the background correction unit 330 may retain captured images up to those used for the virtual viewpoint image being displayed.

Further, a timecode for the time at which a user selects an object may be included in the background correction control instruction information, and the background correction unit 330 may have a capability of generating a corrected background image using captured images corresponding to that timecode.

Similarly, the three-dimensional shape data generation unit 350 may have a capability of retaining foreground data tier a certain time period obtained from the foreground extraction unit 340. Further, there may be a capability of identifying an object to be a part of the background by using foreground data corresponding to the timecode of the time at which a user has selected an object, and outputting coordinate information and mask information corresponding to the object to be a part of the background to the backgrounded target determination unit 380.

As thus described, in extracting the foreground from captured images using background difference method, an object not desired to be displayed as the foreground is selected on a virtual viewpoint image, and the background images for the respective actual cameras are corrected. Thus, only a desired object can be displayed on a virtual viewpoint image as the foreground.

### [Embodiment 2]

In the present embodiment, the foreground ID of a foreground object in each captured image corresponding to a position specified on a virtual viewpoint image is found by finding three-dimensional coordinates of the position specified on the virtual viewpoint image converting the three-dimensional coordinates thus found into two-dimensional coordinates on the captured image, and then using the two dimensional coordinates thus converted.

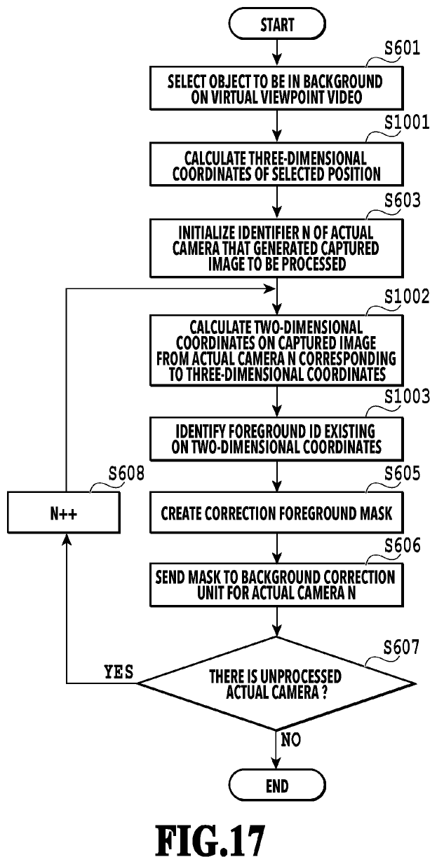

FIG. 17 shows a flowchart of processing performed by the image generation apparatus 220 to be, a part of the background, an object unwanted as the foreground of a virtual viewpoint image. Note that steps for performing the same processing as that in the processing flowchart shown in FIG. 11 in Embodiment 1 are denoted by the same reference numerals as those used in Embodiment 1 to omit detailed description thereof.

First, in S601, the setting reception unit 370 obtains information for identifying an object to be a part of the background that a user has selected using the UI unit 230 from foreground objects in a virtual viewpoint image displayed on the image display apparatus 240. In the present embodiment, coordinates on the virtual viewpoint image are obtained as the object identifying information.

in S1001, based on the coordinate information on the virtual viewpoint of the virtual viewpoint image displayed at the timing at which the user selected the object and the coordinate information on the selected object on the virtual viewpoint image, the coordinates of a straight line connecting these sets of coordinates in the three-dimensional space are calculated. Among the objects located on this straight line, an object closest to the virtual viewpoint is identified as a selected object.

In S603, the backgrounded target determination unit 380 initializes an identifier N for identifying an actual camera. In the present embodiment, the initial value of N is set to 101, and processing is performed starting from the captured image captured and obtained by the actual camera 101.

In S1002, two-dimensional coordinates on a captured image captured by the actual camera N that correspond to the three-dimensional coordinates of the position of the selected object calculated in S1001 are calculated. For example, the two-dimensional coordinates of the position of the selected object on the captured image are calculated based on a straight line connecting the three-dimensional coordinates of the selected object and the three-dimensional coordinates of the actual camera N and on the angle of view and the line-of-sight direction of the actual camera N. In a case where an object exists on a particular two-dimensional plane, the two-dimensional coordinates of the position of the selected object on a captured image may be calculated by projecting the three-dimensional coordinates onto the two-dimensional plane and converting the two-dimensional coordinates on the particular two-dimensional plane into two-dimensional coordinates on the captured image.

In S1003, the backgrounded target determination unit 380 identifies a foreground ID corresponding to an object in a region existing on the two-dimensional coordinates on the captured image from the actual camera N calculated by the three-dimensional shape data generation unit 350. Because a foreground region in the captured image from the actual camera N can be found based on the coordinate information and the mask information in the foreground data, it is possible to detect in which foreground region the two-dimensional coordinates exist.

In S605, the backgrounded target determination unit 380 obtains coordinate information and mask information included in the foreground data corresponding to all the foreground IDs identified in S1003 and generates a correction foreground mask.

The processing after that (S606 to S608) is the same as that in Embodiment 1 and is therefore not described here.

As thus described, in foreground extraction from captured videos using background difference method, the background images for the respective actual cameras are corrected in a short period of time by identification of unwanted foreground using coordinate conversion. An object that a user does not want displayed as the foreground on a virtual viewpoint image can thus be moved to the background.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed con systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present disclosure can shorten the time it takes to generate a proper background image.

This application claims the benefit of Japanese Patent Application No. 2021-117789 filed Jul. 16, 2021, which is hereby incorporated by reference wherein in its entirety.

1. An image processing apparatus comprising at least one processor or circuit configured to function as:
an obtainment unit that obtains a plurality of captured images captured and obtained by a plurality of image capture apparatuses;
a background generation unit that generates a plurality of background images corresponding to the captured images from the respective image capture apparatuses, based on the plurality of captured images;
a foreground extraction unit that extracts, as a foreground region on an object-by-object basis, a difference between each captured image of the plurality of captured images and a background image of the plurality of background images that corresponds to the captured image; and
a determination unit that determines a foreground region corresponding to an object specified by a user, in each of the captured images from the respective image capture apparatuses, wherein
the background generation unit updates each of the plurality of background images based on the determined foreground region in a corresponding one of the captured images from the respective image capture apparatuses.

2. The image processing apparatus according to claim 1, wherein
the determination unit obtains information of association between the captured images from the respective image capture apparatuses which is set in generation of a virtual viewpoint image using the foreground regions extracted by the foreground extraction unit, and determines the foreground region in each of the captured images from the respective image capture apparatuses based on the information of association.

3. The image processing apparatus according to claim 2, wherein
the determination unit identifies the object specified by the user, based on the object that the user specified on the virtual viewpoint image.

4. The image processing apparatus according to claim 2, wherein
the determination unit obtains, as the information of association, shape data indicating a three-dimensional shape in the virtual viewpoint image, and based on the shape data, determines, in each of the captured images from the respective image capture apparatuses, a foreground region corresponding to the object specified by the user from three-dimensional coordinates of a position of the object specified by the user.

5. The image processing apparatus according to claim 2, further comprising:
a shape data generation unit that generates shape data indicating a three-dimensional shape of each object based on the foreground regions obtained by the foreground extraction unit; and
an image generation unit that generates the virtual viewpoint image based on the shape data.

6. The image processing apparatus according to claim 5, wherein
the image generation unit does not use the shape data generated based on the determined foreground region.

7. The image processing apparatus according to claim 5, wherein
the shape data generation unit retains foreground data for a certain time period corresponding to the foreground regions, and
the determination unit determines the foreground region in each of the captured images used to generate the virtual viewpoint image on which the user specified the object.

8. The image processing apparatus according to claim 2, wherein
the background generation unit retains the captured images for a certain time period and uses the captured images used to generate the virtual viewpoint image on which the user specified the object to update the background images.

9. The image processing apparatus according to claim 1, wherein
the determination unit generates a correction foreground mask for masking a region other than the determined foreground region for each of the captured images from the image capture apparatuses, and
the background generation unit updates each of the background images by superimposing, on the background image, an image extracted by application of the correction foreground mask to a corresponding one of the captured images from the respective image capture apparatuses.

10. The image processing apparatus according to claim 1, wherein
for each of the captured images from the respective captured images, the background generation unit has a base background image stored therein in advance, the base background image being generated from a captured image having no possible foreground object, and sets, as an updated background image, an image obtained by superimposing a foreground region corresponding to the object specified by the user onto the base background image.

11. The image processing apparatus according to claim 1, wherein
the background generation unit obtains, from the user, control instruction information indicating whether to update the background images, and in a case where the control instruction information indicates not to update the background images, outputs the background images before update.

12. An image processing method comprising:
obtaining a plurality of captured images captured and obtained by a plurality of image capture apparatuses;
generating a plurality of background images corresponding to the captured images from the respective image capture apparatuses, based on the plurality of captured images;
extracting, as a foreground region on an object-by-object basis, a difference between each captured image of the plurality of captured images and a background image of the plurality of background images that corresponds to the captured image; and
determining a foreground region corresponding to an object specified by a user, in each of the captured images from the respective image capture apparatuses, wherein
in the generating of the background images, each of the plurality of background images is updated based on the determined foreground region in a corresponding one of the captured images from the respective image capture apparatuses.

13. A non-transitory computer readable storage medium storing a program that causes a computer to execute:
obtaining a plurality of captured images captured and obtained by a plurality of image capture apparatuses;
generating a plurality of background images corresponding to the captured images from the respective image capture apparatuses, based on the plurality of captured images;
extracting, as a foreground region on an object-by-object basis, a difference between each captured image of the plurality of captured images and a background image of the plurality of background images that corresponds to the captured image; and
determining a foreground region corresponding to an object specified by a user, in each of the captured images from the respective image capture apparatuses, wherein
in the generating of the background images, each of the plurality of background images is updated based on the determined foreground region in a corresponding one of the captured images from the respective image capture apparatuses.
